(19) United States
(12) Patent Application Publication
(10) Pub. No.: US 2008/0126206 A1
(43) Pub. Date: May 29, 2008

(54) PROVIDING ADVERTISING TO BUYERS OF REAL ESTATE UTILIZING VIRTUAL TOURS

(75) Inventor: Steve Jarrell, Coral Springs, FL (US)

Correspondence Address: EDWARDS ANGELL PALMER & DODGE LLP, P.O. BOX 55874, BOSTON, MA, 02205, US

(73) Assignee: TRF SYSTEMS, INC., Pompano Beach, FL (US)

(21) Appl. No.: 11/944,909

(22) Filed: Nov. 26, 2007

Related U.S. Application Data
(60) Provisional application No. 60/861,230, filed on Nov. 27, 2006.

(51) Int. Cl. G06Q 30/00

(52) U.S. Cl. 705/14

(57) ABSTRACT

A method of providing virtual tour based advertising comprising providing a virtual tour technology to a real estate agent which enables the real estate agent to create a virtual tour, uploading the virtual tour to a host server such that the virtual tour is available for viewing across a distributed computing network, the uploaded virtual tour including space for display of advertising in conjunction with the virtual tour; and purchasing from one of a creator of the virtual tour technology, a host of a virtual tour and the real estate agent an advertisement placement for display with one or more virtual tours created by the real estate agent.

### CROSS-REFERENCE TO RELATED APPLICATIONS

This Application is a Non-Provisional of Provisional application No. 60/861,230, entitled PROVIDING ADVERTISING TO BUYERS OF REAL ESTATE UTILIZING VIRTUAL TOURS, filed on Nov. 27, 2006 (35 USC 119(e)) and incorporated herein by reference.

### TECHNICAL FIELD

The present invention generally relates to methods, business models and systems of providing advertising to a targeted audience over the Internet by subsidizing the creator of a technology enabling real estate agents to create, store, maintain and display virtual tours on the World Wide Web and an advertiser who wishes to display its advertisements in conjunction with the agent's virtual tours displaying the advertisement with the virtual tour for a fee.

### BACKGROUND OF THE INVENTION

Over five million homes are bought and sold in the US every year. Statistics show that the majority of homebuyers begin their search on the Internet, and the vast majority of these buyers prefer to view virtual tours of the homes. Virtual tours allow the potential buyer to save time and money by viewing an inventory of products or services from their computer connected to the Internet. Virtual tours offer numerous benefits for both the buyer and seller.

However, virtual tours create additional transaction costs for the sale of a home as a seller or seller's agent must procure the technology to create the tour and arrange for hosting the virtual tour on the Internet.

### BRIEF SUMMARY OF THE INVENTION

Embodiments of the inventions described herein alleviate the challenges posed by the transaction costs associated with virtual tours by providing methods, business models and systems of providing advertising to a targeted audience over the Internet while subsidizing the creator of the technology enabling the associated content, and in particular, by allowing real estate agents to create, store, maintain and display virtual tours on the World Wide Web by the creator of the technology charging an advertiser who wishes to display their advertisements in conjunction with the agent's virtual tours.

There is provided a method of providing virtual tour based advertising comprising: purchasing virtual tour technology; providing the virtual tour technology to a real estate agent at a discounted cost; and purchasing from one of the technology creator, virtual tour creator, or virtual tour host an advertisement placement for display with one or more virtual tours created by the real estate agent.

In a further embodiment, purchasing the virtual tour technology comprises obtaining a license for the virtual tour technology.

In another embodiment, the method further includes hosting an application implementing virtual tour technology. In an alternative embodiment, the method further includes contracting with a service provider for the service provider to host an application implementing virtual tour technology.

In a further embodiment, the advertisement is selected from the group consisting of: banner advertisements, pop-up advertisements, video advertisements, and audio advertisements.

Still another embodiment of the subject invention is directed to a system for virtual tour based advertising, comprising: a central controller in communication with one or more remote computers via a distributed computing network; a first computer programmed to create a virtual tour and send the virtual tour to the central controller; a second computer programmed to send an advertisement to the central controller; and a third computer programmed to receive and display communications from the central controller, wherein the central controller communicates the virtual tour and the associated advertisement to the third computer and wherein privileges to send the virtual tour to the central controller is provided at a discounted cost to the user of the first computer.

In a further embodiment, the first computer is programmed to edit the virtual tour and communicate modifications to the central controller.

In another embodiment, the central controller is programmed to communicate a webpage to the computer and receive modifications generated by the webpage.

In another embodiment, the central controller is programmed to communicate a link for the virtual tour to a real estate portal.

In another embodiment, the central controller is programmed to communicate a menu to the one or more of the computers, the menu consisting of one or more of the following group of options: add tours, edit tours, help, announcements, news, view profile, edit profile, auto-linking setup, view software license, download software, view reports, view summaries and upgrade.

In another embodiment, the central controller is programmed to communicate a webpage to the second computer and receive the advertisement through the webpage.

In another embodiment, the central controller communicates the virtual tour and the advertisement to the third computer as a webpage.

In another embodiment, the central controller is programmed to verify the identity of one or more of the computers. In a further embodiment, the central controller is programmed to verify the authorization of one or more of the computers.

In another embodiment, the first computer is programmed to create and modify virtual tours easily and quickly by arranging multiple photos, graphics, videos and/or other media types, organizing these media types into a specific order to create scenes for the tour, determining the length of time each scene will be displayed, determining the transition effect that will take place when moving to the next scene, enhancing these scenes by adding text and/or voice to each scene, stitching multiple individual images into a single panoramic image that will scroll in the tour, add music to the tour, and then upload the tour automatically to the central controller.

Still another embodiment of the subject invention is directed to a central controller for facilitating virtual tour based advertising, wherein the central controller communicates with remote computers via a distributed computing network and privileges to send the virtual tour to the central controller are provided at a discounted cost to the creator of the virtual tour that uses the first programmed computer to create and upload the virtual tour. The central controller comprises: a memory storing an instruction set and virtual tour data; and a processor for running the instruction set, the processor being in communication with the memory and the distributed computing network, wherein the processor is operative to: receive a virtual tour from the first computer; receive advertisements from a second computer; and display the virtual tour and the advertisement to a third computer.

In a further embodiment, the advertisement is selected from the group consisting of: banner advertisements, pop-up advertisements, video advertisements, and audio advertisements.

It should be appreciated that the present invention can be implemented and utilized in numerous ways including, without limitation, as a process, an apparatus, a system, and a device. The invention can be implemented entirely or partially in software and/or hardware. The software can be contained on or in any computer readable medium. Certain embodiments of the invention and related aspects, features, and benefits will become more readily apparent from the following description and the accompanying drawings.

### BRIEF DESCRIPTION OF THE DRAWINGS

The drawings generally are to illustrate principles of the invention and/or to show certain embodiments according to the invention. The drawings are not necessarily to scale. Like reference symbols in the various drawings generally indicate like elements. Each drawing is briefly described below.

FIG. 1 is a flowchart showing a method for virtual tour based advertising in accordance with the invention;

FIG. 2 is a block diagram showing interactions between the components of an embodiment of the inventions herein;

FIG. 3 is a screenshot of the loading of components of the virtual tour in accordance with the invention;

FIGS. 4a and 4b are screenshots of the stitching step illustrating combining multiple images in accordance with invention;

FIG. 5a is a screenshot of a login interface for agents and/or advertisers to access Web-based services;

FIG. 5b is a screenshot of an agent control panel for online virtual tours;

FIG. 5c is a screenshot of an interface for agents to manage virtual tours;

FIG. 6 is a screenshot of an interface for advertisers to upload banners;

FIG. 7 is a screenshot of a virtual tour including an advertisement in accordance with the invention; and

FIG. 8 is a flow chart showing a method for virtual tour based advertising in accordance with another embodiment of the invention.

### DETAILED DESCRIPTION OF THE INVENTION

In brief overview, embodiments of the present invention solve the challenges described herein of utilizing virtual tours in the real estate market. Various embodiments of the present invention accomplish this through the use of advertising by individuals and entities such as banks, mortgage providers, title insurance providers, homeowners' insurance providers and home inspectors. The following description is provided to illustrate various embodiments of the invention, but the description is not intended to limit the scope of the invention.

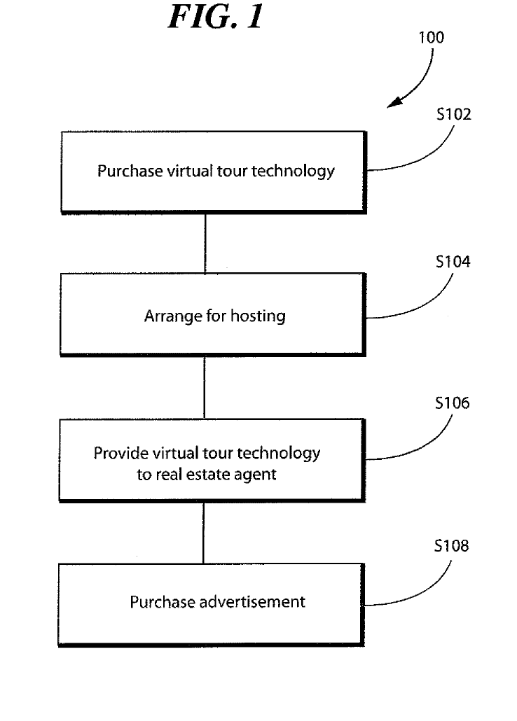

Referring to FIG. 1, a flow chart 100 of a virtual tour based advertising business model is depicted. In step S102, virtual tour technology is purchased. Virtual technology may be purchased by a variety of individuals and entities including but not limited to: banks, mortgage providers, title insurance providers, homeowners insurance providers, home inspectors, credit counseling agencies, real estate agents including buyer's agents, attorneys, home improvement contractors, home improvement stores including hardware stores, moving companies, employers, chambers of commerce, municipalities, and government agencies including the U.S. Department of Housing and Urban Development the Federal Housing Authority. The purchase of the virtual tour technology may be in the form of a license to use the virtual tour software required to create and/or host the virtual tour.

In step S104, arrangements are made to host the virtual tour technology. A purchaser of the virtual tour technology may host the service or application on new or existing infrastructure as is described herein. Alternatively, the purchaser may contract with a third party such as a service provider to host the service or application. The definition of a service provider includes any individual or entity operating one or more computers or other network devices capable of responding to requests from users for information, applications and/or services residing on the one or more computers. For example, the definition of a service provider includes providers of interactive computer services under 47 U.S.C §230(f), i.e. one who “provides or enables computer access by multiple users to a computer server [ . . . ]”

In step S106, the virtual tour technology is provided to one or more real estate agents at a discounted cost. The virtual tour technology may also be provided at no cost to the real estate agent. As used herein, “real estate” agent includes both licensed and unlicensed individual or entities seeking to sell real property. This includes individuals and entities seeking to sell property owned by the individual or entity, e.g. a homeowner selling their own home. The technology may be provided by granting the agent access to the technology in many ways, including by a login and password, a code authorizing the agent to create a profile, or a Uniform Resource Locator (URL) address directing the agent to a registration page. Access to the virtual tour may be limited in many ways, including, but not limited to allowing the agent to create a defined number of virtual tours, allowing access for a defined time period, allowing virtual tours to be created only for a geographic area, or a combination of the above.

In step 108, one or more advertisement placements are purchased by vendors for display with one or more virtual tours created by the real estate agent. The advertisements may be of any type, including but not limited to: banner advertisements, pop-up advertisements, video advertisements and audio advertisements. Preferably, the vendor purchases advertising placement or space from the technology source. However, advertising space may also be purchased from the creator or host of the virtual tour.

Thus, virtual tours are created by real estate agents at little or no cost because the technology for creating and hosting the virtual tours is subsidized by one or more advertisement placements. Additionally, prospective buyers benefit from the ability to view virtual tours at no cost, while receiving advertisements that may be of interest to the prospective buyers, given their interest in purchasing real estate. Sellers of properties also benefit as their homes can be shown to a much wider audience using the virtual tours.

Advertisers also benefit through more effective advertisement placements. By placing advertisements in the virtual tour, advertisers gain access to a “captive audience” of prospective buyers who can be expected to spend a significant amount of time viewing one or more virtual real estate tours. Additionally, advertisements for services or products sought by prospective buyers, such as mortgages or homeowners insurance, may perform above average compared to other Internet advertising, as measured in advertising metrics such as click-through rate.

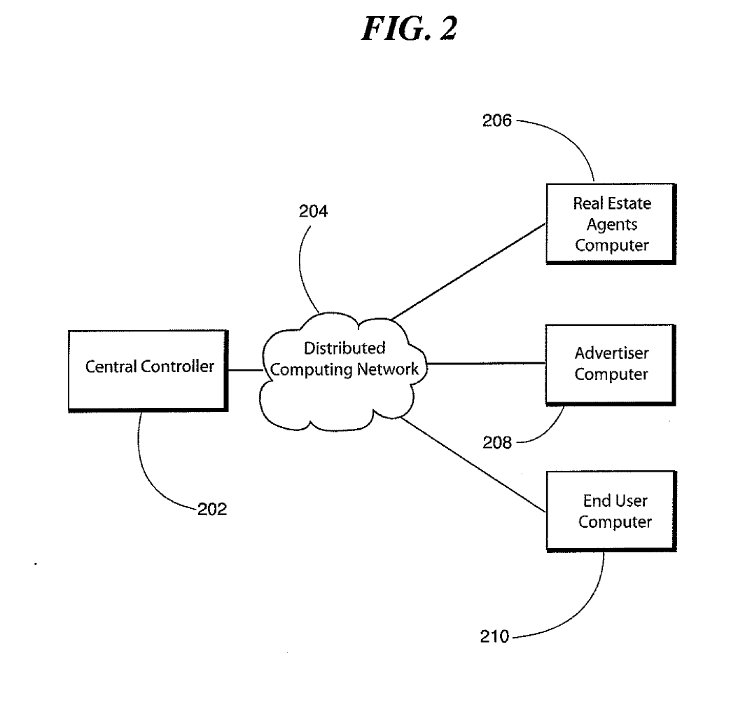

Referring now to FIG. 2, a system 200 is depicted including a server 202 operating as a central control, connected to remote computing devices 206, 208, and 210 through a distributed computing network 204.

The central controller 202 may be implemented as one or more servers known to those skilled in the art that are intended to be operably connected to a network so as to operably link to a plurality of remote computing devices 206, 208, and 210 via a distributed computer network 204. As illustrated, the central controller 202 typically includes a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the central controller 202 may be used for storing data, client applications and the like utilized by computing devices 206, 208, and 210. The hard disk drives of the central controller 202 also are typically provided for purposes of booting and storing the operating system, other applications or systems that are to be executed on the central controller 202, paging and swapping between the hard disk and the RAM. The central controller may be communicatively coupled to one or more databases, network attached storage devices (NAS) or storage area networks (SAN) to provide additional storage capacity.

Computing devices 206, 208, and 210 can be a device capable of communication across a distributed network and displaying a visual tour hosted at the central controller 202, such as a desktop computer, laptop computer, personal digital assistant, cellular telephone and the like now known and later developed. Computing devices 206, 208, and 210 must have displays and be capable of interacting with Central Controller 212 and each other by way of a web browser by way of example. The display may be any of a number of known devices for displaying images responsive to output signals from computing devices 206, 208, and 210. Such displays include, but are not limited to, cathode ray tubes (CRTs), liquid crystal displays (LCDs), plasma screens and the like. Although a simplified diagram is illustrated in FIG. 2 such illustration shall not be construed as limiting the present invention to the illustrated embodiment. It should be recognized that the signals being output from the computer can originate from any of a number of devices including PCI or AGP video boards or cards mounted within the housing of computing devices 206, 208, and 210 are operably coupled to the microprocessors and the displays thereof.

Computing devices 206, 208, and 210 typically includes a central processing unit including one or more micro-processors such as those manufactured by Intel or AMD, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of computing devices 206, 208, and 210 is for purposes of booting and storing the operating system, other applications or systems that are to be executed on the computer, paging and swapping between the hard disk and the RAM and the like. In one embodiment, the application programs, such as software for creating, editing and or viewing a virtual tour, reside on the hard disk drive for performing the functions in accordance with the transcription system. In another embodiment, the hard disk drive simply has a browser for accessing an application hosted within the distributed computing network. Computing devices 206, 208, and 210 can also utilize a removable computer readable medium such as a CD or DVD type of media or flash memory that is inserted therein for reading and/or writing to the removable computer readable media.

The central controller 202 and the one or more computing devices 206, 208, and 210 are connected via a distributed computing network 204, whether wired or wireless, as is now known or later developed. The distributed computing network 204 may include one or more of the following: LAN, WAN, Internet, intranet, TCP\IP, UDP, Virtual Private Network, Ethernet, Gigabit Ethernet and the like.

A first computing device 206 is programmed to create a virtual tour and send the completed virtual tour to the central controller for hosting. The first computing device 206 may contain software stored persistently on computing device 206 to create a virtual tour.

This software allows the user such as a real estate agent to create a virtual tour of a property at computing device 206. This software allows the local loading and stitching of photographs, video and audio to create a virtual tour. The software also enables the tour to be created easily by allowing the agent to add text to each scene, arrange the scenes in any order, add music to the virtual tour, and allowing the agent to crop and enhance the scene's brightness and contrast. The software then allows for the uploading of the completed tour to that agent's account on the host central controller 202 across distributed computing network 204. This software provides the capability to create a virtual tour with placeholders for advertisements within the tour.

The virtual tour technology allows creation of the entire tour by the real estate agent before uploading the tour to central controller 202. As a result, the agent is able to determine how long the individual scenes will be displayed, and the transition effects that will take place as the person viewing the tour advances from scene to scene. The agent can add unlimited text to each scene describing it in its entirety and select music to be played with the tour (royalty free music could be provided to be played with the tour if they so desire). The first computing device 206 is programmed to allow the agent to record voice on any or all scenes using a microphone plugged into their computer, and this voice is automatically compressed and uploaded with the tour and played automatically with each scene. The technology also enables the tour creator to create local CD based tours, Organize their tours on their local computer so they can easily locate and modify them in the future if necessary, and easily share scenes between tours (for example if they wanted to have common shots of a neighborhood they could use them easily on a number of tours.)

The virtual tour may be sent to the central controller 202 through any method or technologies suitable for the transport of information across the distributed computing network 204. These technologies include, but are not limited to: attachment in an email, selecting a file through a webpage; use of HTML commands GET or POST; JINI®, available from Sun Microsystems, Inc. of Santa Clara, Calif.; CORBA; and the use of sockets.

A second computing device 208 used by the advertiser is programmed to send an advertisement to the central controller 202 which inserts the advertisement into the virtual tour. The advertisement may be sent by any method or technologies suitable for the transport of information across the distributed computing network 204 including, but not limited to the methods and technologies discussed herein.

A third computing device 210 utilized by the end user wishing to utilize the virtual tour is programmed to receive and display communications from central controller 202. The communications may be received and displayed by any conventional browser program stored on third computing device 210. By way of non-limiting example, a web browser as described herein may receive a webpage encoded in HTML and display the webpage. In a preferred embodiment, a Flash® viewer is utilized.

Once loaded, computing device 206 is capable of editing the virtual tour and communicating the modifications to central controller 202. Computing device 206 may use methods and technology similar to those described herein for the first client to both edit the virtual tour and communicate with the central controller 202. Modifications to the virtual tour may also be done once the tour is uploaded to the central controller using a web browser in lieu of using the client software.

In some embodiments, central controller 202 is programmed to communicate a link for the virtual tour to a real estate portal. The link may be any text or code capable of uniquely identifying the virtual tour, such as a URL, an index for the virtual tour in a database, or a code for the virtual tour. Real estate portals include Internet sites allowing users to browse and/or search real estate listings from multiple sources, such as Realtor.com, Homes.com, Yahoo.com, and local multiple listing services (MLS).

In some embodiments, central controller 202 is programmed to communicate a menu to one or more of computing devices 206, 208. The menu may vary depending on which computing device 206, 208, is accessing the menu. The menu may contain options, including but not limited to: add tours, edit tours, help, announcements, news, view profile, edit profile, auto-linking setup, view software license, download software, view reports, view summaries and upgrade.

In some embodiments, central controller 202 is programmed to verify the identity (authentication) and authorization of one or more computing devices 206, 208 and/or the users of those computing devices 206, 208, and 210. Authentication can be accomplished by examining one or more credentials from the following categories: something the user/client is (e.g. fingerprint or retinal pattern, DNA sequence, signature recognition, other biometric identifiers, or Media Access Control (MAC) address), something the user/client has (e.g. ID card, security token, or software token), and something the user/client knows (e.g. password, pass phrase, or personal identification number (PIN)). Authorization is a process of determining whether the authenticated user/client is allowed to view information or perform actions. The concepts of authentication and authorization are well known and thus not further described herein.

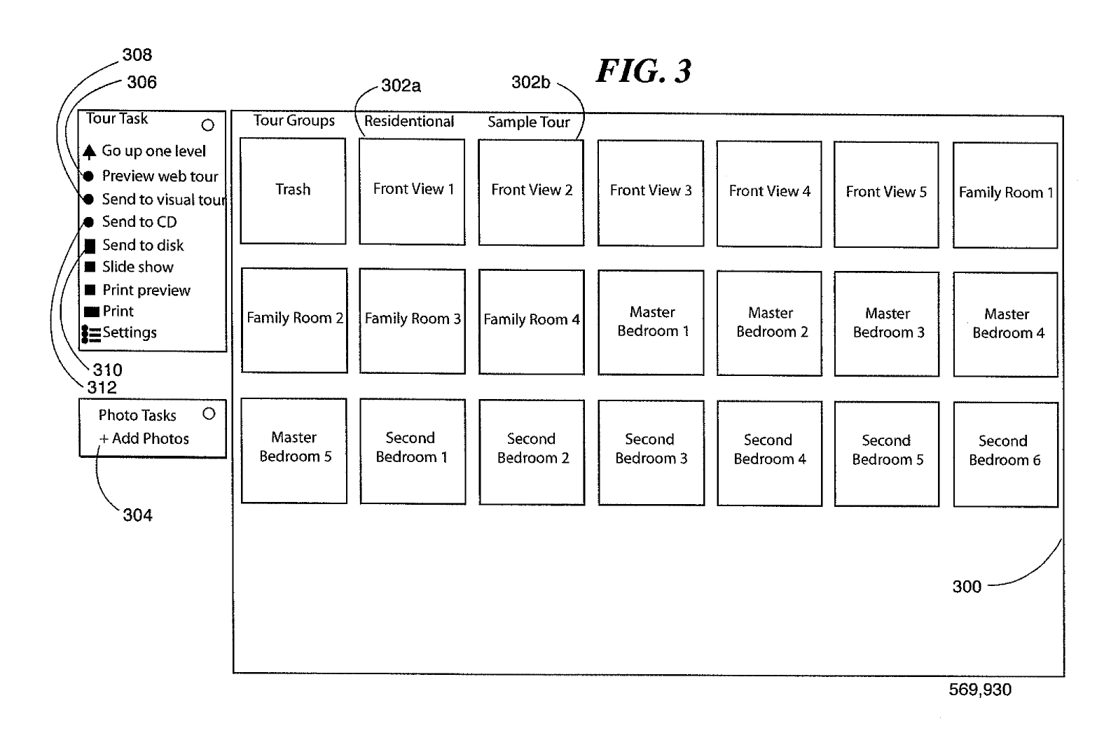

Referring now to FIG. 3, in some embodiments, first computing device 206 is programmed with software that is installed on first computing device 206. FIG. 3 is a screenshot of the components to be incorporated in the virtual tour in accordance with one embodiment of such software. An interface 300 is displayed on first computing device 206 allowing a user to create a virtual tour. The virtual tour may include multiple photographs 302a, 302b, etc. The user may import photographs into the visual tour through the “Add photos” icon 304. The user may also preview the web tour (306), send the web tour to a central controller 202 (308), burn the web tour on a compact disc (310) or save the web tour to a disk (312), either internal or external to first computing device 206.

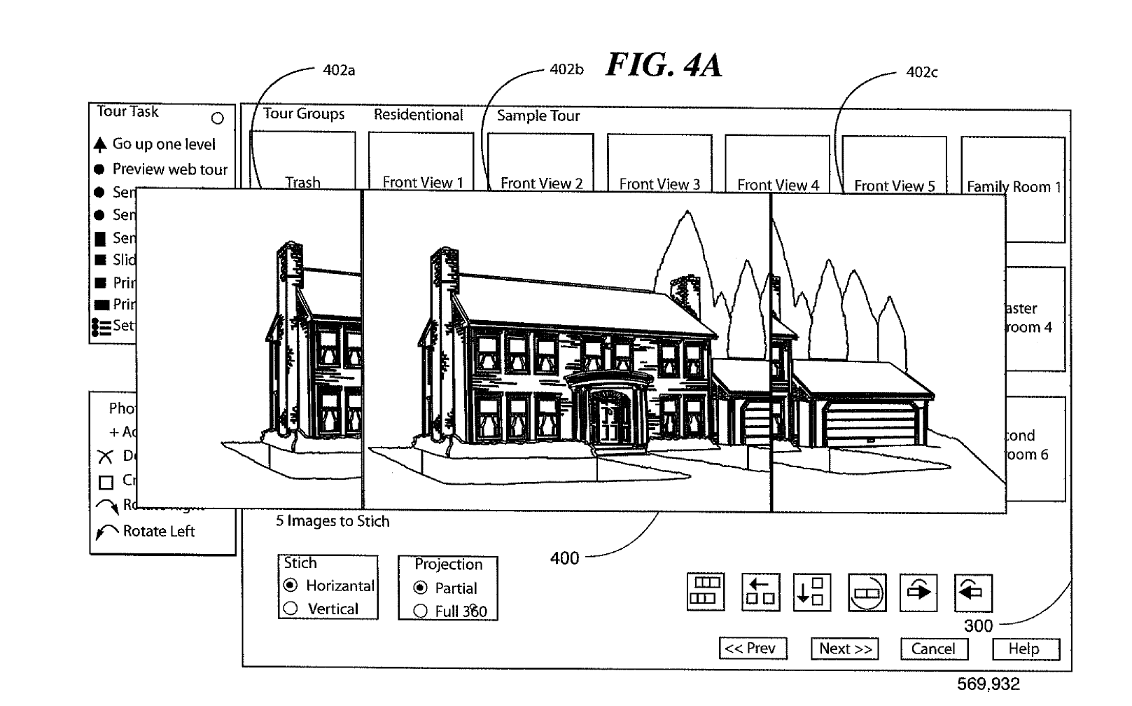

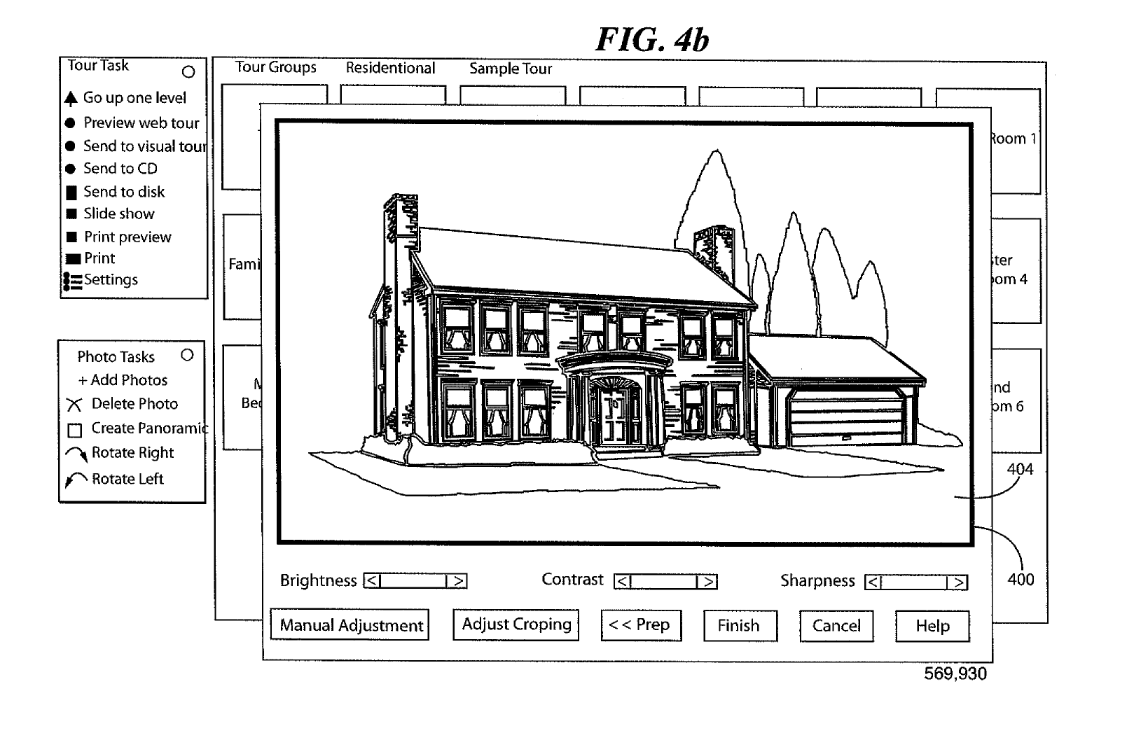

Referring now to FIGS. 4a and 4b, in additional embodiments, first computing device 206 is programmed to stitch multiple images into a single image. FIGS. 4a and 4b shows an interface 400 within the virtual tour interface 300. In FIG. 4a, three images 402a, 402b, 402c are selected for stitching. In FIG. 4b, a composite image 404 has been created from the three images 402a, 402b, and 402c. Image stitching is well known and thus not further described herein.

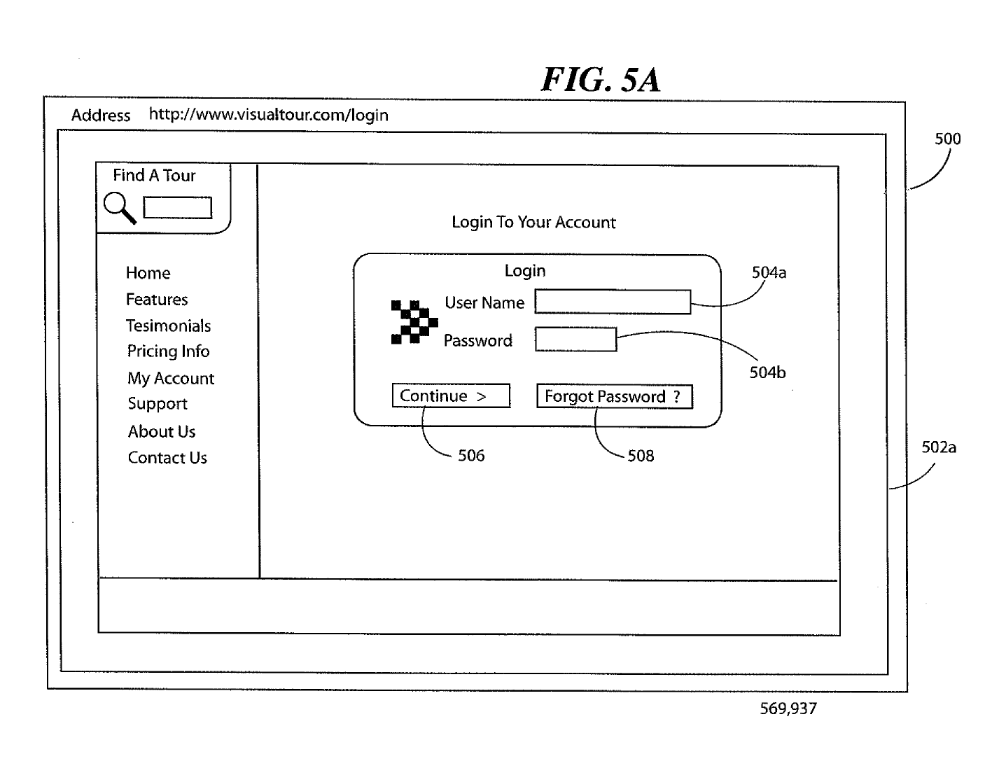

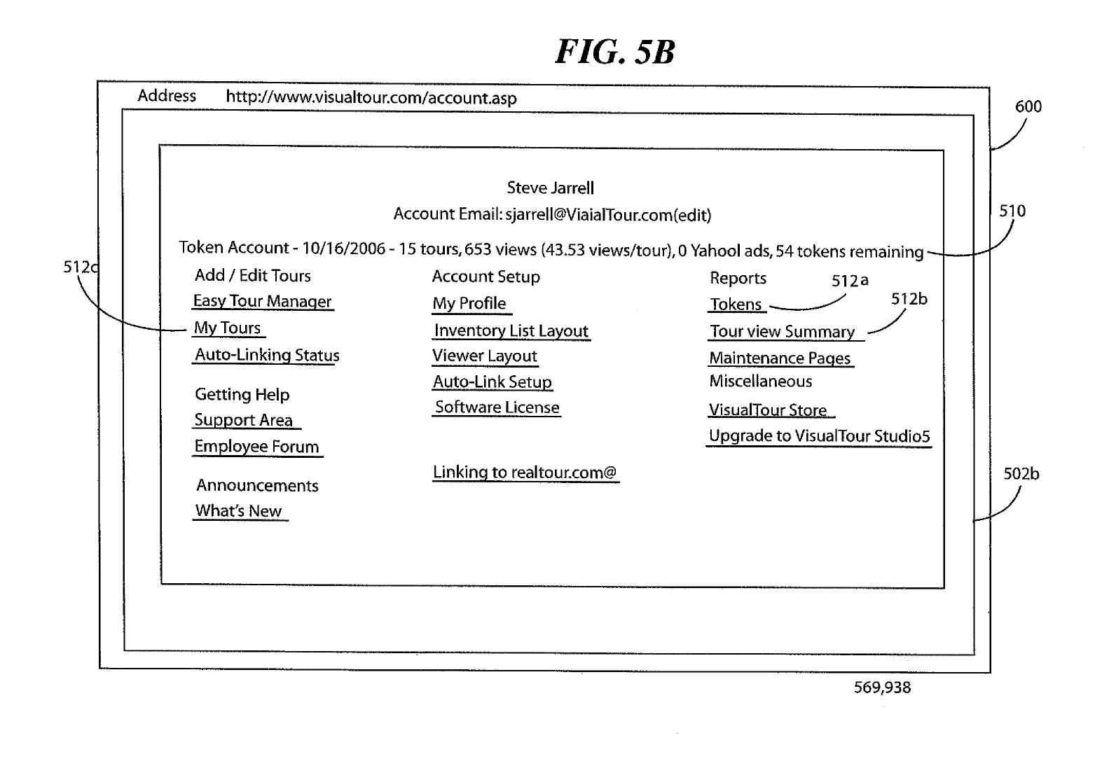

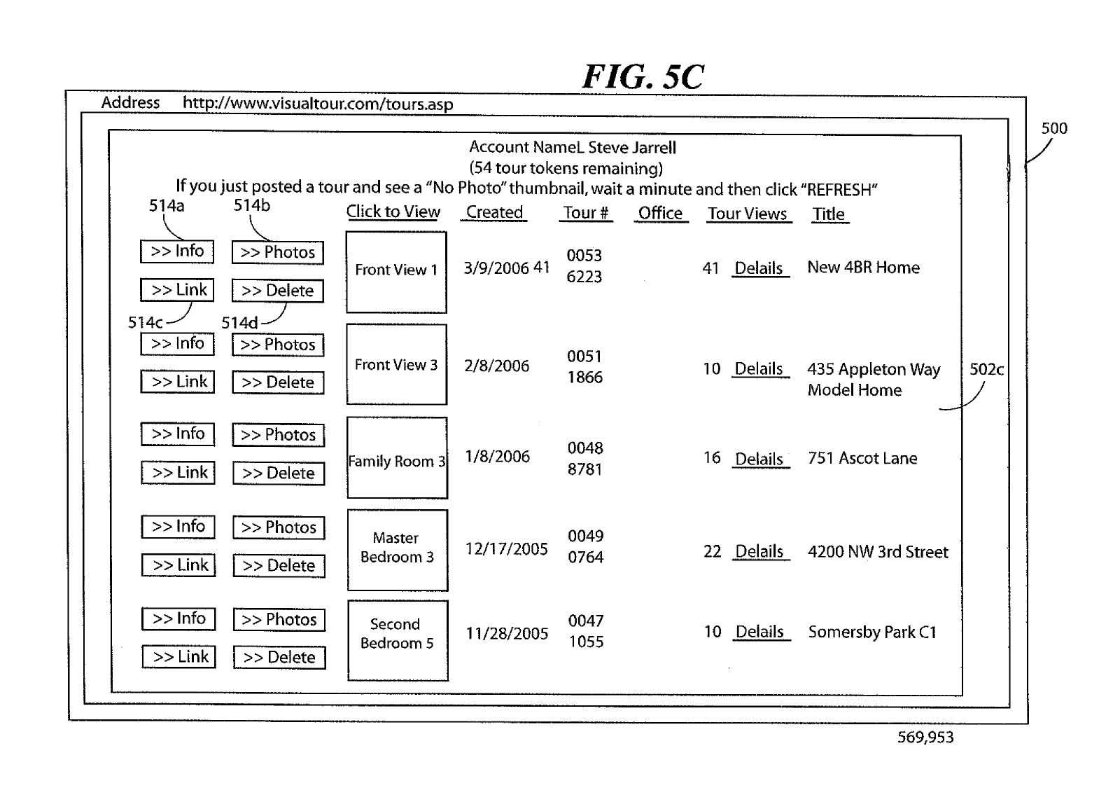

Referring now to FIGS. 5a, 5b and 5c, an Internet browser window 500 as described herein is depicted. In some embodiments, one or more of computing devices 206, 208, and 210 may access information pertaining to a user's account through a web site 502a utilizing a graphical user interface. The user may be required to login by entering a user name in a first field 504a and a password in a second field 504b and pressing the “CONTINUE” link 506. If the user has forgotten or misplaced a password, the user may press the “FORGOT PASSWORD?” link 508 to retrieve the password. Once logged in, the user is presented another web page 502b. The web page 502b may contain information about the account 510 as well as links to several administrative and reporting option 512a, 512b, etc.

By selecting the “My Tours” link 512c, a real estate agent is shown a new web page 502c, which contains information about the agent's virtual tours. The agent may click on icons to obtain information about a virtual tour (514a), view the photos in the virtual tour (514b), obtain a link, such as a URL, to the virtual tour (514c) or delete the tour (514d).

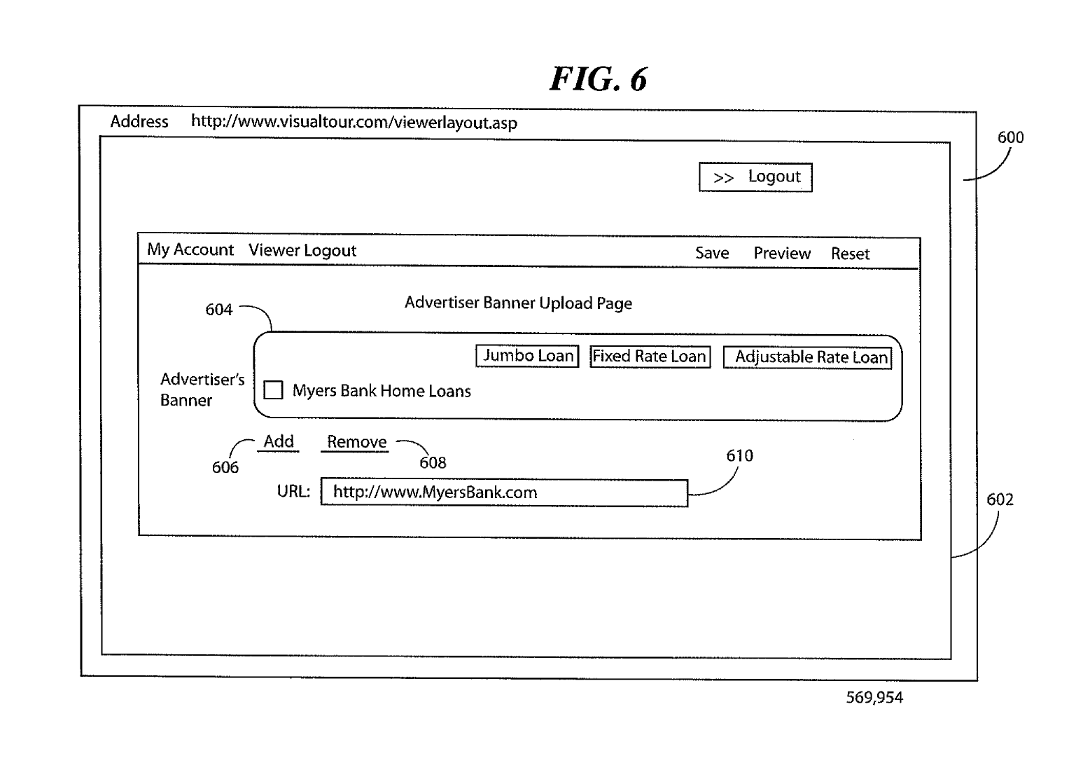

Referring now to FIG. 6, an Internet browser window 600 as described herein is depicted. In some embodiments, the advertiser's computing device 208 may send one or more advertisements through a web site 602 to the central controller 202. The user of computing device 208, e.g. an advertiser or the advertiser's agent may view advertisers current advertisements 604 and may add (606) or remove (608) one or more of the current advertisements. To add a new advertisement, the user enters the URL for the advertisement in a field 610. In other embodiments, the user may browse one or more disks on second computing device 208 for advertisements and upload those advertisements to the central controller 202.

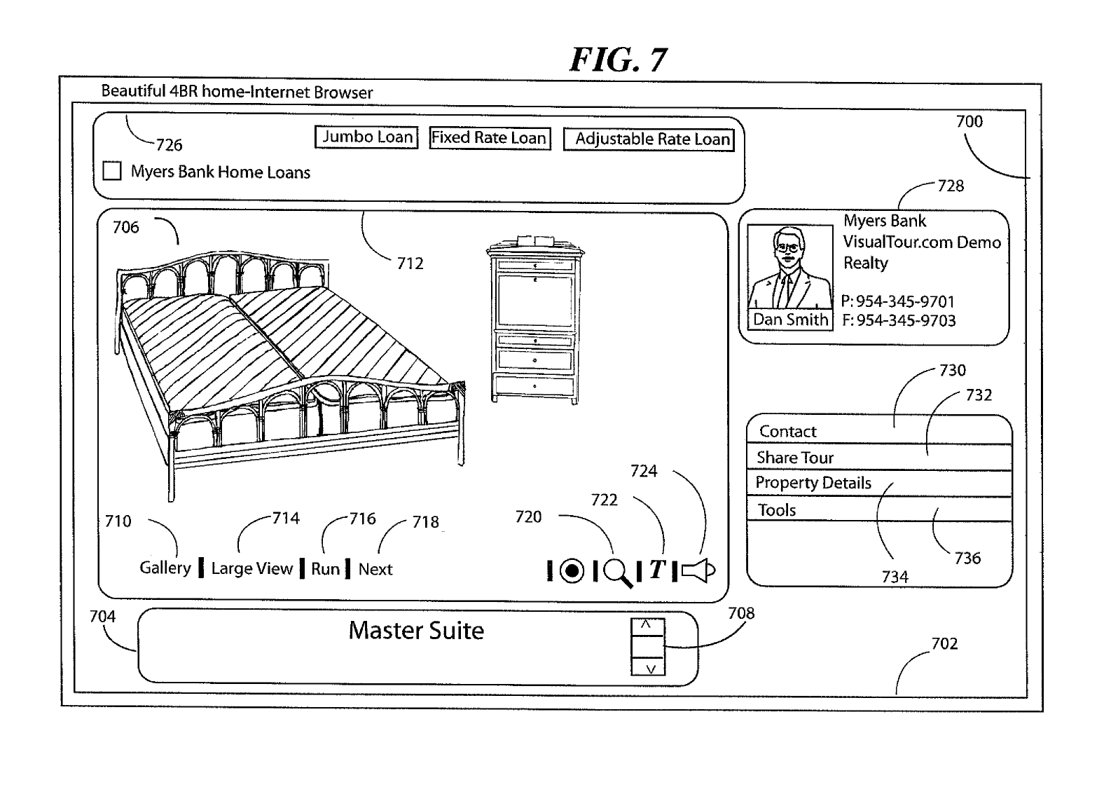

Referring now to FIG. 7, an Internet browser window 700 as described herein is depicted. The browser window 700 contains a web page 702, which in turn displays a virtual tour. The virtual tour may contain a description 704 of one or more photographs 706. The user may scroll through the description 704 using a scroll bar 708 if necessary due to the length of the description 704. Clicking on the “Gallery” link causes a set of thumbnails to be displayed. The user can select one of these thumbnails to view a full sized photograph 706. In some embodiments, the virtual tour may alter the field of view, e.g. in an oscillating pattern such as panning, to show all areas of a photograph 706. For example, such oscillation may be necessary where multiple photographs have been stitched together as described herein. Clicking on the “Large View” link 712 causes a large view of the photograph 706 currently being displayed to be shown. Clicking on the “Run” icon 714 causes the virtual tour to cycle through all photographs 706 in the virtual tour. The user can manually move forward and/or backwards through links 716 and 718, respectively. The user can zoom in and/or out by clicking on the magnifying glass link 720. Text size may be modified through link 722. Voice and music volume may be adjusted through link 724.

One or more advertisements 726 are displayed as part of the virtual tour. Information on the real estate agent or agency 728 may also be displayed. The user can obtain information how to contact the agent or agency and view additional properties in the agent or agency's inventory by clicking on the “CONTACT” link 730. A user can share the virtual tour, either by email or by downloading an executable file, by clicking on the “SHARE TOUR” link 732. The user can obtain information about the property such as the price and the number of bedrooms by clicking on the “PROPERTY DETAILS” link 734. The user can access tools such as a mortgage calculator by clicking on the “TOOLS” link 736.

The functions of several elements may, in alternative embodiments, be carried out by fewer elements, or a single element. Similarly, in some embodiments, any functional element may perform fewer, or different, operations than those described with respect to the illustrated embodiment. Also, functional elements (e.g., modules, databases, computers, clients, servers and the like) shown as distinct for purposes of illustration may be incorporated within other functional elements, separated in different hardware or distributed in a particular implementation. In particular, the functionality of computing device 206 may be implemented across multiple remote computing devices.

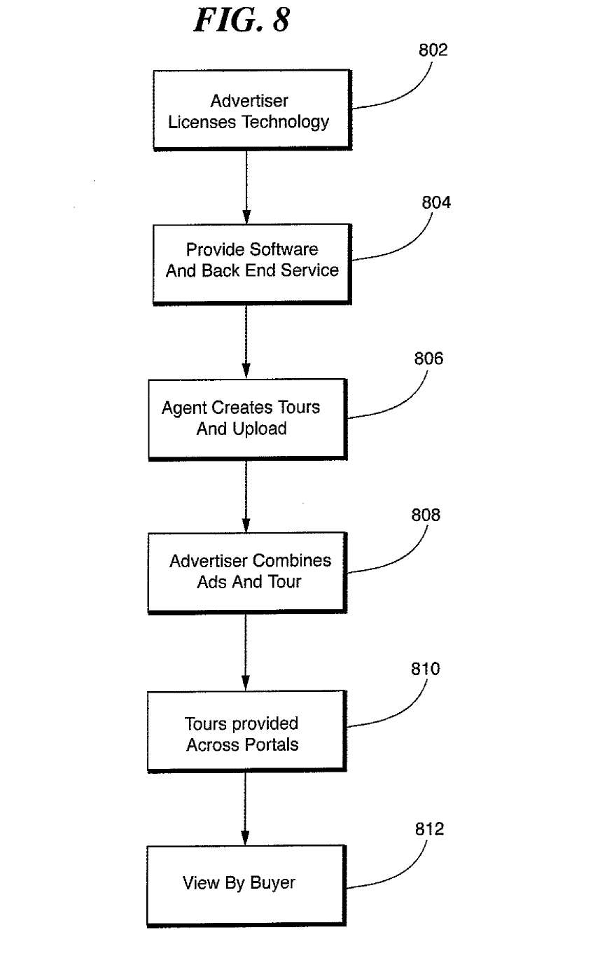

Reference is now made to FIG. 8 in which an alternative embodiment of the invention is provided. The primary difference between the method of FIG. 8 and the method of FIG. 2 is that the advertiser takes control of the process and determines the amount to be spent by the real estate agent in preparing the tour and placing the advertising. In other words, the advertiser takes control of what is now a new targeted advertising vehicle.

In a first step, the advertiser licenses the virtual tour creation technology in step 802. In step 804, the advertiser provides the software to the agent to create and upload tours at the agent's computing device 206. The agent creates the tour at computing device 206 and uploads the tour to central controller 202 (in the manner as discussed before) in a step 806. The advertiser, working from computing device 208, uploads advertisements to central controller 202 across the distributed computing network 204 as discussed above and combines the advertisements with the created virtual tour in a step 808. Central controller 202 then provides the virtual tour including the advertisement across multiple portals in a step 810. End users interested in real estate view the virtual tours from end user computing devices 210 as discussed above in a step 812.

When providing the software and back end service such as hosting in step 804, the advertiser may in fact provide the software for free to the agent in exchange for the advertiser's ability to advertise on the virtual tour. In effect, the cost of the advertisement placement to the advertiser is merely the cost of the license obtained in step 802. It is also contemplated that the advertiser in combining ads in step 808 may in fact “lease out” or sell advertisement placement to third party advertisers to subsidize the cost of the virtual tour technology to the advertiser.

In the alternative, to maintain the independence of the real estate agent and the advertiser, the advertiser could charge a fee of the real estate agent, although substantially less than the cost of the virtual tour technology itself.

While certain embodiments according to the invention have been described, the invention is not limited to just the described embodiments. Various changes and/or modifications can be made to any of the described embodiments without departing from the spirit or scope of the invention. Also, various combinations of elements, steps, features, and/or aspects of the described embodiments are possible and contemplated even if such combinations are not expressly identified herein.

What is claimed as new and desired to be protected by Letters Patent of the United States is:

1. A method of providing virtual tour based advertising comprising:
providing a virtual tour technology to a real estate agent which enables the real estate agent to create a virtual tour using client based software, upload the virtual tour to a host server such that the virtual tour is available for viewing across a distributed computing network, the uploaded virtual tour includes space for display of advertising in conjunction with the virtual tour; and
purchasing from one of a creator of the virtual tour technology, a host of a virtual tour and the real estate agent an advertisement placement for display with one or more virtual tours created by the real estate agent.

2. The method of claim 1, wherein the real estate agent purchases the virtual tour technology wherein purchasing the virtual tour technology comprises obtaining a license for the virtual tour technology.

3. The method of claim 1, further comprising hosting an application implementing making the virtual tour accessible across the distributed network.

4. The method of claim 1, further comprising contracting with a service provider for the service provider to host the virtual tour.

5. The method of claim 1, wherein the advertisement is selected from the group consisting of: banner advertisements, pop-up advertisements, video advertisements, and audio advertisements.

6. A system for virtual tour based advertising, comprising:
a central controller in communication with one or more remote computing devices via a distributed computing network;
a first remote computing device programmed to create a virtual tour and send the virtual tour to the central controller across the distributed computing network;
a second computing device programmed to send an advertisement to the central controller; and
a third computing device programmed to receive and display communications from the central controller, wherein the central controller makes the virtual tour and the advertisement accessible to the third computing device, and wherein the cost of creating and sending is discounted as a function of a price paid to place the advertisement on the virtual tour.

7. The system of claim 6, wherein the first computing device is programmed to edit the virtual tour and communicate modifications to the virtual tour to the central controller either using the client software or a web browser across the distributed computing network.

8. The system of claim 7, wherein the central controller is programmed to communicate a webpage to the fourth client and receive modifications generated by the webpage.

9. The system of claim 7, wherein the central controller is programmed to communicate a link for the virtual tour to a real estate portal.

10. The system of claim 7, wherein the central controller is programmed to communicate a menu to the one or more of the remote computing devices, the menu consisting of one or more of the following group of options: add tours, edit tours, help, announcements, news, view profile, edit profile, auto-linking setup, view software license, download software, view reports, view summaries and upgrade.

11. The system of claim 6, wherein the central controller is programmed to communicate a webpage to the second computing device and receive the advertisement through the webpage.

12. The system of claim 6, wherein the central controller communicates the virtual tour and the advertisement to the third computing device as a webpage.

13. The system of claim 6, wherein the central controller is programmed to verify the identity of one or more of the computing devices.

14. The system of claim 6, wherein the central controller is programmed to verify the authorization of one or more of the computing devices.

15. The system of claim 6, wherein the first computing device is programmed to stitch multiple images into a single image. Allows the agent to drag and drop the scenes into any order that they wish for the buyer to see the tour.

16. A central controller for facilitating virtual tour based advertising, wherein the central controller communicates with one or more remote computing devices via a distributed computing network, wherein privileges to send the virtual tour to the central controller are provided at a discounted cost to the user of a first client as a function of a price paid to place advertisement on the virtual tour, and wherein the central controller comprises:
(a) a memory storing an instruction set and virtual tour data; and
(b) a processor for running the instruction set, the processor being in communication with the memory and the distributed computing network, wherein the processor is operative to:
receive a virtual tour from the first computing device;
receive advertisements from a second computing device; and
display the virtual tour and the advertisement at a third computing device.

17. The central controller of claim 16, wherein the processor is further operative to receive modifications to the virtual tour from the first computing device.

18. The central controller of claim 16, wherein the advertisement is selected from the group consisting of: banner advertisements, pop-up advertisements, video advertisements, and audio advertisements.

19. A method of providing virtual tour based advertising comprising:
licensing a virtual tour technology to an advertiser;
the advertiser providing the virtual tour technology to a real estate agent, the virtual tour technology enabling the real estate agent to create a virtual tour;
the real estate agent creating the virtual tour and then uploading the virtual tour to a host server so that the virtual tour is available for viewing across a distributed computing network, the uploaded virtual tour including space for display of advertisement in conjunction with the virtual tour; and
said advertiser placing advertisements in the spaces within the virtual tour for viewing by an end user across the distributed computing network in conjunction with the virtual

20. The method of claim 19, wherein the advertiser provides the virtual tour technology for free to the real estate agent.

21. The method of claim 19, wherein the advertiser sells access to said advertising spaces to one of the real estate agent or third party advertisers.

22. The method of claim 19, wherein said advertiser hosts the virtual tour.
